(19) United States
(12) Patent Application Publication
(10) Pub. No.: US 2022/0204265 A1
(43) Pub. Date: Jun. 30, 2022

(54) DEVICES FOR TOUCHLESS OPERATION OF A PRODUCT OUTLET DOOR OF A VENDING MACHINE

(71) Applicant: Invenda Group AG, Luzern (CH)

(72) Inventors: Jon Raymond Brezinski, Engelberg (CH); Srdjan POZNIC, Novi Sad (RS); Branislav (Borislav) TEJIC', Novi Sad (RS); Igor (Ivan) BARANOVSKI, Novi Sad (RS); Karl Jonatan BRZEZINSKI, Stockholm (SE)

(73) Assignee: Invenda Group AG, Luzern (CH)

(21) Appl. No.: 17/562,026

(22) Filed: Dec. 27, 2021

Related U.S. Application Data
(60) Provisional application No. 63/132,529, filed on Dec. 31, 2020.

(51) Int. Cl. B65G 1/06; E05F 15/616; G07F 11/02

(52) U.S. Cl. CPC B65G 1/06; E05F 15/616; G07F 11/02; E05Y 2900/608; E05Y 2201/638; E05Y 2201/668; E05Y 2201/626

(57) ABSTRACT

A devices for touchless operation of a product outlet door of a vending machine includes a frame mountable within an interior of a vending machine; a lever comprising a lever rod coupled to the frame and rotatable with respect to the frame about a lever rod rotation axis, wherein the lever rod is couplable to the product outlet door of the vending machine; and an actuator configured to rotate the lever rod from a first lever rod position to a second lever rod position to cause the product outlet door to rotate about its rotation axis from its closed position to its open position so as to open the product outlet door.

### CROSS-REFERENCE TO RELATED APPLICATIONS

This application claims the benefit of U.S. Provisional Patent Application No. 63/132,529, filed on Dec. 31, 2020, which is hereby incorporated by reference in its entirety.

### FIELD OF THE INVENTION

The present invention relates to the field of vending machines and, more particularly, to touchless vending machines.

### BACKGROUND OF THE INVENTION

Typically, a vending machine has a product delivery compartment that receives a purchased product from a product delivery mechanism of the vending machine, a product outlet through which a user may pull the purchased product, and a product outlet door that closes the product outlet. The user typically has to manually open the product outlet door.

FIGS. 1A and 1B show a portion of a prior art vending machine 90 including a product delivery compartment 92, a product outlet 94 and a product outlet door 96 having horizontal product outlet door rotation axis 96(1). FIG. 1A shows product outlet door 96 in its closed position 96a, and FIG. 1B shows product outlet door 96 in its open position 96b. In order to open product outlet door 96, the user has to rotate product outlet door 96 about its rotation axis 96(1) towards an interior of product delivery compartment 92, hold product outlet door 96 open, and pull purchased product 80 from product delivery compartment 92 through product outlet 94. Product delivery door 96 typically closes automatically due to gravity force acting thereon.

### SUMMARY OF THE INVENTION

Some embodiments of the present invention may provide a device for operating a product outlet door of a vending machine having a horizontal product outlet door rotation axis, the device may include: a frame mountable within an interior of a vending machine; a lever may include a lever rod coupled to the frame and rotatable with respect to the frame about a lever rod rotation axis, wherein the lever rod is couplable to the product outlet door of the vending machine; and an actuator configured to rotate the lever rod from a first lever rod position to a second lever rod position to cause the product outlet door to rotate about its rotation axis from its closed position to its open position so as to open the product outlet door.

In some embodiments, the actuator is configured to enable the lever rod to freely rotate between the second lever rod position and the first lever rod position to cause the product outlet door to freely rotate about its rotation axis from its open position to its closed position due to gravity force acting on the product outlet door so as to cause the product outlet door to close.

In some embodiments, the device may include: a door pulley couplable to the product outlet door and rotatable with respect to the product outlet door about a door pulley rotation axis; wherein the door pulley contacts the lever rod such that rotation of the lever rod causes the door pulley to at least one of roll over and skim on the lever rod, and causes the product outlet door to rotate about its rotation axis so as to cause the product outlet door to open or to close.

In some embodiments, the lever rod may include: a first lever rod portion; and a second lever rod portion at an obtuse angle with respect to the first lever rod portion; wherein the lever rod rotation axis is between the first lever rod portion and the second lever rod portion.

In some embodiments, the actuator may include: a disc cam coupled to the frame and rotatable with respect to the frame about a disc cam rotation axis, wherein the disc cam is configured to: when rotated from a first disc cam position to a second disc cam position, cause rotation of the lever rod from the first lever rod position to the second lever rod position so as to open the product outlet door; and when rotated from the second disc cam position to the first disc cam position, enable the lever rod to freely rotate between the second lever rod position and the first lever rod position due to gravity force acting on the product outlet door so as to cause the product outlet door to close; and a motor configured to rotate the disc cam.

In some embodiments, the motor is configured to rotate the disc cam in one direction.

In some embodiments, the disc cam may include: a disc cam pulley coupled to the disc cam and rotatable with respect to the disc cam about a disc cam pulley rotation axis; wherein the disc cam pulley contacts the lever rod such that rotation of the disc cam causes the disc cam pulley to at least one of roll over and skim on the lever rod so as to cause rotation of the lever rod between the first lever rod position and the second lever rod position.

Some embodiments of the present invention may provide a device for operating a product outlet door of a vending machine having a horizontal product outlet door rotation axis, wherein the device may include: a frame mountable within an interior of a vending machine; a basket configured to receive a purchased product from a vending machine, wherein the basket is couplable to the product outlet door of the vending machine and movable within the frame between a lowered basket position and an elevated basket position; and an actuator configured to elevate the basket from a lowered basket position to an elevated basket position to cause the product outlet door to rotate about its door rotation axis from its closed position to its open position so as to open the product outlet door.

In some embodiments, the actuator is configured to lower the basket from the elevated basket position to the lowered basket position to cause the product outlet door to freely rotate about its rotation axis from its open position to its closed position due to gravity force acting on the product outlet door so as to cause the product outlet door to close.

In some embodiments, the device may include: at least one door wheel couplable to the product outlet door and rotatable with respect to the product outlet door about at least one door pulley rotation axis; wherein the at least one door pulley contacts at least one top lateral edge of the basket such that elevation and lowering of the basket causes the at least one door wheel to roll over the at least one top lateral edge of the basket and causes the product outlet door to rotate about its rotation axis so as to cause the product outlet door to open or to close.

In some embodiments, the actuator may include: a cable coupled to the basket; a lever may include a lever rod coupled to the frame and rotatable with respect to the frame about a lever rod rotation axis, wherein the lever rod is coupled to the cable; and a motor configured to; rotate the lever rod from a first lever rod position to a second lever rod position to elevate the basket from the lowered basket position to the elevated basket position so as to open the product outlet door; and rotate the lever rod from the second lever rod position to the first lever rod position to lower the basket from the elevated basket position to the lowered basket position so as to cause the product outlet door to close.

In some embodiments, the actuator may include: a linear gear coupled to the frame; a circular gear meshed with the linear gear; and a motor coupled to the basket and coupled to the circular gear to rotate the circular gear about a circular gear rotation axis, wherein the motor is configured to: rotate the circular gear in a first rotation direction to elevate the basket from the lowered basket position to the elevated basket position and to cause opening of the product outlet door; and rotate the circular gear in a second rotation direction to lower the basket from the elevated basket position to the lower basket position and to cause closure of the product outlet door due to gravity force acting on the product outlet door.

Some embodiments of the present invention may provide a product delivery box for a vending machine, wherein the product delivery box may include the device as described hereinabove.

Some embodiments of the present invention may provide a vending machine including the device as described hereinabove.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIGS. 1A and 1B show a portion of a prior art vending machine including a product delivery compartment, a product outlet and a product outlet door having horizontal product outlet door rotation axis;

FIG. 2A and 2B are schematic illustrations of a device for operating a product outlet door of a vending machine, according to some embodiments of the invention;

FIGS. 2C and 2D are schematic 3D diagrams of a device for operating a product outlet door of a vending machine, according to some embodiments of the invention;

FIGS. 3A and 3B are schematic illustrations of a device for operating a product outlet door of a vending machine, including an elevatable basket and a lever-based actuator, according to some embodiments of the invention;

FIGS. 3C, 3D and FIG. 3E are schematic 3D diagrams of a device for operating a product outlet door of a vending machine, including an elevatable basket and a lever-based actuator, according to some embodiments of the invention;

FIGS. 4A and 4B are schematic illustrations of a device for operating product outlet door of a vending machine, including an elevatable basket and a gear-based actuator, according to some embodiments of the invention; and

FIGS. 4C and 4D are schematic 3D diagrams of a device for operating a product outlet door of a vending machine, including an elevatable basket and a gear-based actuator, according to some embodiments of the invention.

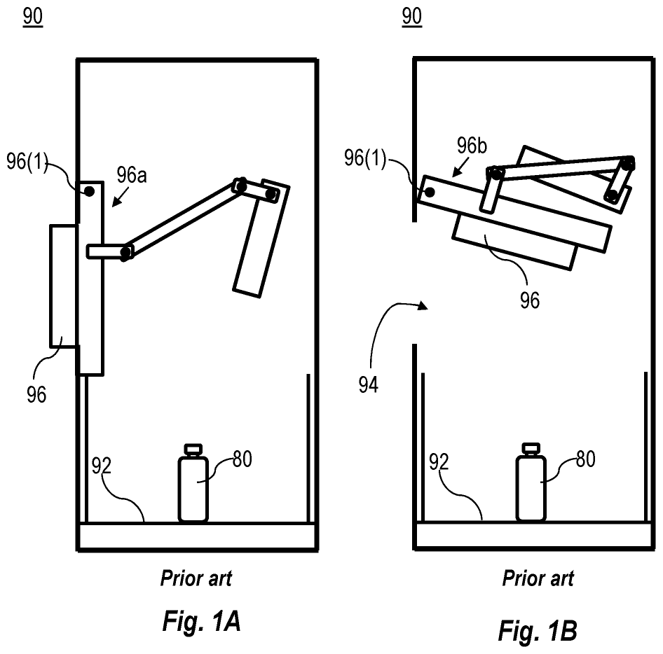

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Various embodiments of the present invention provide devices for touchless operation of a product outlet door of a vending machine. The devices may be configured to automatically operate a product outlet door of a vending machine having a horizontal product outlet door rotation axis. The devices may be configured to open the product outlet door of the vending machine. The devices may be configured to enable the product outlet door of the vending machine to close due to gravity force acting on the product outlet door. In some embodiments, the devices may be configured to elevate the purchased product from a bottom of a product delivery compartment of the vending machine close to a product outlet.

The devices may provide cheap and compact solution for automatic operation of the product outlet door of the vending machine. The devices may be easily retrofitted to existing vending machines or implemented in new vending machines. The devices may eliminate a need for a user of the vending machine to touch the product outlet door and/or the interior of the product delivery compartment of the vending machine in order to pull the purchased product from the vending machine.

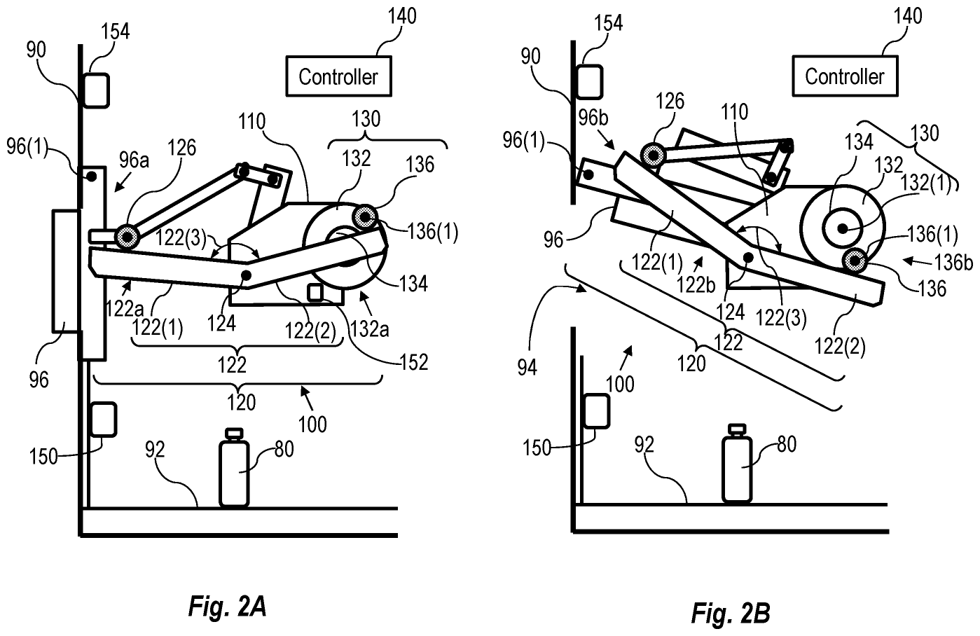

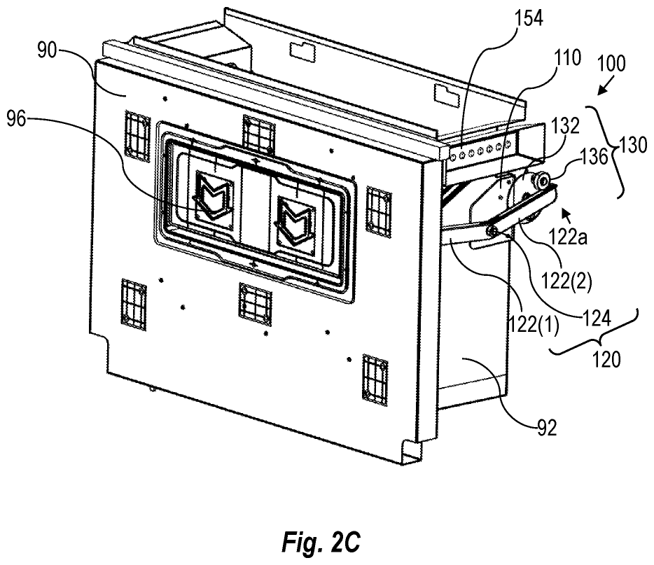

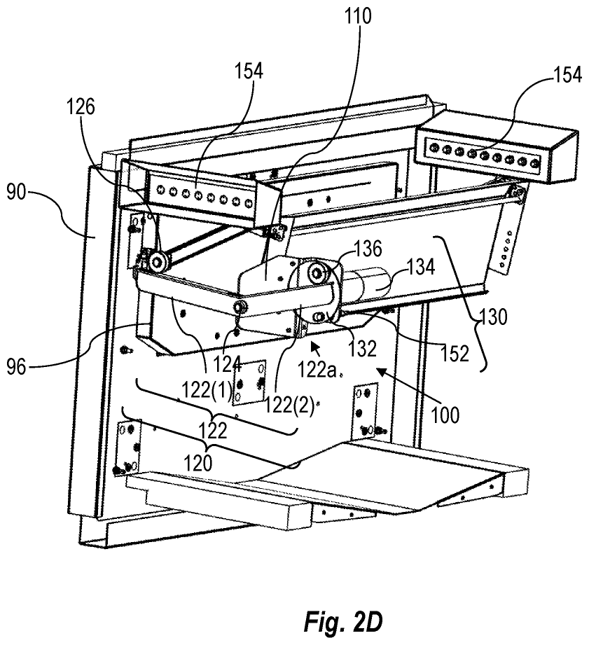

Reference is now made to FIG. 2A and 2B, which are schematic illustrations of a device 100 for operating a product outlet door 96 of a vending machine 90, according to some embodiments of the invention.

Reference is also made to FIGS. 2C and 20, which are schematic 3D diagrams of a device 100 for operating a product outlet door 96 of a vending machine 90, according to some embodiments of the invention.

Device 100 may be configured to operate a product outlet door 96 of a vending machine having horizontal product outlet door rotation axis 96(1). According to some embodiments of the invention, device 100 may include a frame 110, a lever 120 and an actuator 130.

Frame 110 may be mountable within an interior of vending machine 90. For example, frame 110 may be mountable within product delivery compartment 92 of vending machine 90. Frame 110 may support at least some components of device 100. Frame 110 may couple at least sortie components of device 100 to vending machine 90.

Lever 120 may include a lever rod 122 coupled to frame 110 and rotatable with respect to frame 110 about a lever rod rotation axis 124. Lever rod rotation axis 124 may be parallel, or substantially parallel, to product outlet door rotation axis 96(1).

Lever rod 122 may be coupled to product outlet door 96 of vending machine 90. Actuator 130 may be configured to rotate lever rod 122 from a first lever rod position 122a to a second lever rod position 122b. Rotation of lever rod 122 from first lever rod position 122a to second lever rod position 122b may cause product outlet door 96 to rotate about its rotation axis 96(1) from its closed position 96a to its open position 96a so as to open product outlet door 96.

Actuator 130 may be configured to enable lever rod 122 to freely rotate between second lever rod position 122b and first rod position 122a. Free rotation of lever rod 122 between second lever rod position 122b and first rod position 122a may cause product outlet door 96 to freely rotate about its rotation axis 96(1) from its open position 96b to its closed position 96a due to gravity force acting on product outlet door 96 so as to cause product outlet door 96 to close.

In some embodiments, device 100 may include a door wheel 126. Door wheel 126 may be coupled to product outlet door 96 and may be rotatable with respect to product outlet door 96 about a door wheel rotation axis 126(1). Door wheel rotation axis 126(1) may be parallel, or substantially parallel, to lever rod rotation axis 124. Door wheel 126 may be coupled to product outlet door 96 such that door wheel 126 may contact lever rod 122. Rotation of lever rod 122 may cause door wheel 126 to roll over and/or skim on lever rod 122 and may cause product outlet door 96, coupled to door wheel 126, to rotate between its closed position 96a and its open position 90, depending on the direction of rotation of lever rod 122.

Coupling lever rod 122 to product outlet door 96 via door wheel 126 may eliminate a need for rigid coupling of lever rod 122 to product outlet door 96.

Having no rigid coupling between lever rod 122 and product outlet door 96 may enable manual opening of product outlet door 96 independent, of operation of device 100. In this manner, product outlet door 96 may be manually opened by the user independent of operation of device 100 (e.g., in the case of failure of device 100). This may, for example, ensure constant working flow of vending machine 90, e.g., even in the case of failure of device 100. This may, for example, prevent damage to device 100 when product outlet door 96 is manually opened.

Having no rigid coupling between lever rod 122 and product outlet door 96 may enable product outlet door 96 to close due to gravity force acting on product outlet door 96. In this manner, there is no risk of damaging the user by product outlet door 96. In this manner, there is no risk of causing damage to device 100 by the hand of the user or other obstacles within product outlet 96.

In some embodiments, lever rod 122 may include a first lever rod portion 122(1) and a second lever rod portion 122(2). In some embodiments, first lever rod portion 122(1) and second lever rod portion 122(2) may be at an obtuse angle 122(3) with respect to each other. In some embodiments, lever rod rotation axis 124 may be between first lever rod portion 122(1) and second lever rod portion 122(2). In some embodiments, first lever rod portion 122(1) may contact door wheel 126. In some embodiments, second lever rod portion 122(2) may be coupled to actuator 130.

In some embodiments, actuator 130 may include a disc cam 132 and a motor 134. Disc cam 132 may be coupled to frame 110 and rotatable with respect to frame 110 about a disc cam rotation axis 132(1). In some embodiments, disc cam rotation axis 132(1) may be parallel, or substantially parallel, to lever rod rotation axis 124.

Rotation of disc cam 132 from a first disc cam position 132a to a second disc cam position 132b may cause rotation of lever rod 122 from first lever rod position 122a to second lever rod position 122b so as to open product outlet door 96. As long as disc cam 132 is in second disc cam position 132b, lever rod 122 may remain in second lever rod position 132b, and product outlet door 96 may remain open.

Rotation of disc cam 132 from second disc cam position 132b to first disc cam position 132a may enable lever rod 122 to freely rotate between second lever rod position 122b and first lever rod position 122a so as to cause product outlet door 96, coupled to lever rod 122, to close due to gravity force acting on product outlet door 96.

Motor 134 may be a rotation motor configured to rotate disc cam 132. In some embodiments, motor 134 may be coupled to frame 110. Motor 134 may be configured to rotate disc cam 132 in one direction only (e.g., in a clockwise or counterclockwise direction) to cause both opening and closure of product outlet door 96. This may, for example, eliminate a need for an electric circuity that controls the direction of rotation of motor 134. Furthermore, in this manner there is no risk of damaging device 100 or the user, e.g., in the case of failure of one of electrical components of device 100. For example, in the case of faulty in electrical connections or failure of one of sensors of device 100, motor 134 may continuously rotate in the same direction which will cause product outlet door 96 to continuously open and close without a risk of damaging the user and/or device 100.

In some embodiments, disc cam 132 may include a disc cam wheel 136. Disc cam wheel 136 may be coupled to disc cam 132 and rotatable with respect to disc cam 132 about a disc cam wheel rotation axis 136(1). Disc cam wheel rotation axis 136(1) may be parallel, or substantially parallel, to disc cam rotation axis 132(1). Disc cam wheel 136 may be coupled to disc cam 132 such that disc cam wheel 136 may contact lever rod 122. Rotation of disc cam 132 may cause disc cam wheel 136 to roll over and/or skim on lever rod 122 and to cause rotation of lever rod 122 between first lever rod position 122a and second lever rod position 122b, depending on the direction of rotation of disc cam 132.

In some embodiments, device 100 may include a controller 140. Controller 140 may operate actuator 130. In some embodiments, controller 140 may receive, from a processing of vending machine 90, one or more control signals indicative of a delivery of purchased product 80 into product delivery compartment 92 of vending machine 90. Upon receiving the one or more control signals, controller 140 may cause actuator 130 to rotate lever rod 122 from first lever rod position 122a to second lever rod position 122b so as to open product outlet door 96. In some embodiments, controller 140 may be configured to cause actuator 130 to hold lever rod 122 in second lever rod position 122b for a predefined time interval. After the predefined time interval has lapsed, actuator 130 may cause lever rod 122 to freely rotate between second lever rod position 122b and first rod position 122a so as to cause product outlet door 96 to close. In some embodiments, device 100 may include one or more sensors 150 configured to detect an obstacle (e.g., a hand of the user) within product outlet 94/product delivery compartment 92. For example, one or more sensors 150 may be, or may include, one or more optical sensors. If one or more sensors 150 detect an obstacle within product outlet 94/product delivery compartment 92, controller 140 may cause actuator 130 to hold lever rod 122 in second lever rod position 122b, e.g., for addition predefined time interval or until one or more sensors 150 indicate that the obstacle has been removed.

In some embodiments, controller 140 may operate motor 134. Upon receiving the one or more control signals, controller 140 may control motor 134 to rotate disc cam 132 from first disc cam position 132a to second disc cam position 132b so as to open product outlet door 96. In some embodiments, device 100 may include one or more sensors 152 configured to detect that disc cam 132 has reached its second disc cam position 132b and control motor 134 to terminate the rotation of disc cam 132. For example, one or more sensors 152 may be, or may include, one or more limit sensors (e.g., a micro switch, limit switch, inductive sensor, capacitive sensor, optical sensor, etc.). In some embodiments, controller 140 may control motor 134 to hold disc earn 132 in second disc cam position 132b for the predefined time interval to keep product outlet door 96 open for the predefined time interval. After the predefined time interval has lapsed, controller 140 may control motor 134 to rotate disc cam 132 from second disc cam position 132b to first disc cam position 132(a) so as to cause product outlet door 96 to close. Sensor 152 may detect that disc cam 132 has reached first disc cam position 132a and control motor 134 to terminate the rotation of disc cam 132. In some embodiments, if one or more sensors 150 detect the obstacle within product outlet 94/product delivery compartment 92, controller 140 may control motor 134 to hold disc cam 132 in second disc cam position 132b, e.g., for addition predefined time interval or until one or more sensors 150 indicate that the obstacle has been removed.

In some embodiments, device 100 may include one or more sensors 154 configured to detect whether product outlet door 96 of vending machine 90 is in its closed position 96a or is in its open position 96b. For example, one or more sensors 154 may be, or may include, one or more optical sensors. Controller 140 may be configured to further control the operation of actuator 130 (e.g., the operation of motor 134) based on readings of one or more sensors 154.

In various embodiments, motor 134 may be configured to stop or to rotate to its initial position if a current applied on motor 134 exceeds a predefined current value. Current that exceeds the predefined current value may be indicative of, for example, a large force being applied on, for example, lever rod 122. This may, for example, prevent damage to motor 134.

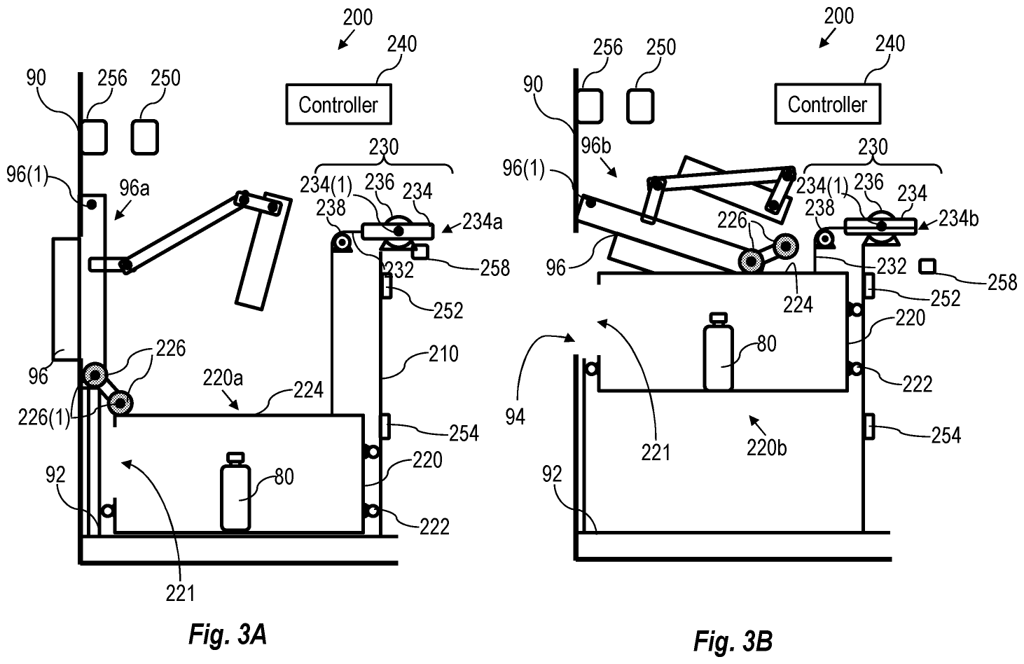

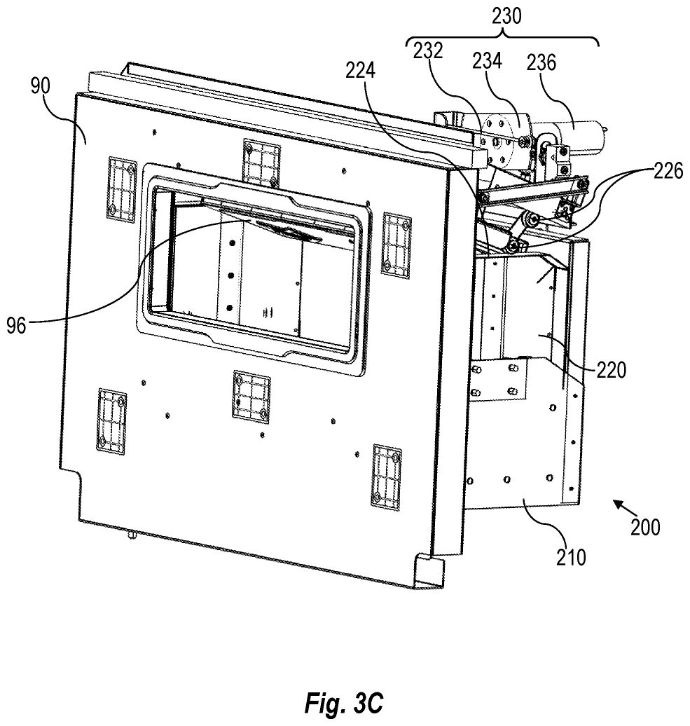

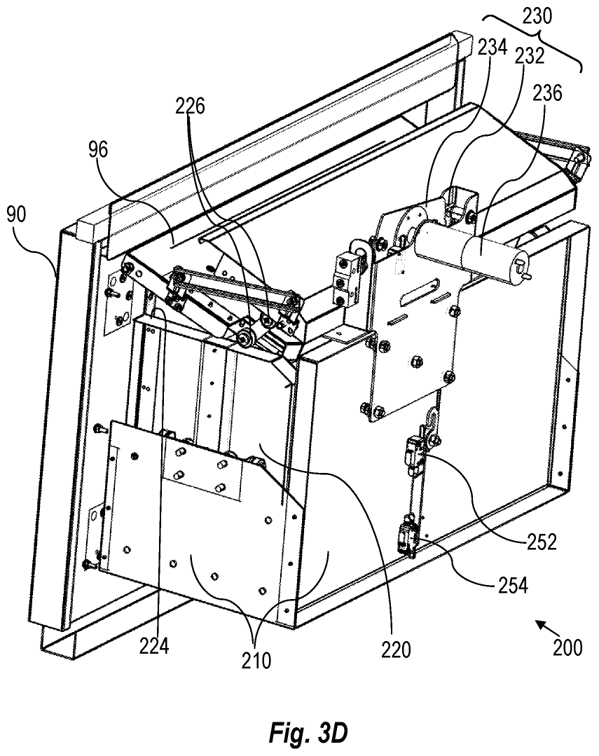

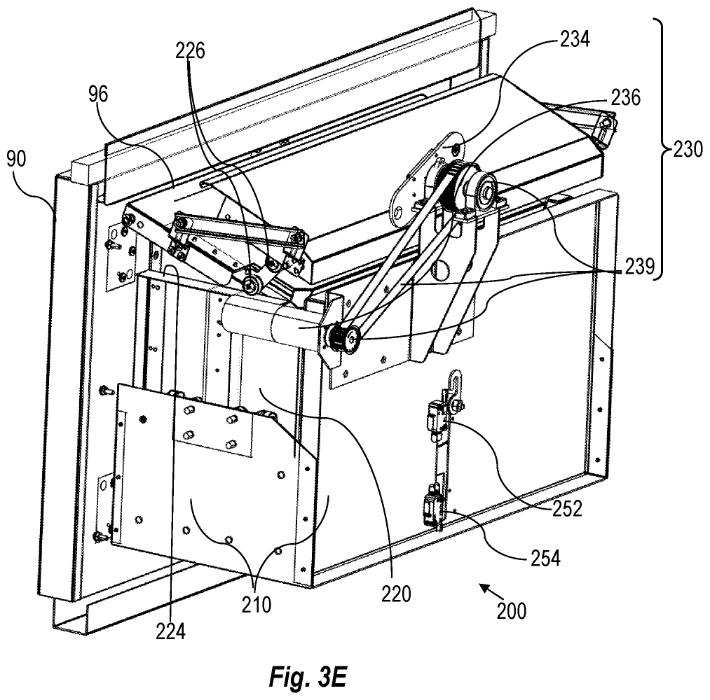

Reference is now made to FIGS. 3A and 3B, which are schematic illustrations of a device 200 for operating a product outlet door 96 of a vending machine 90, including an elevatable basket and a lever-based actuator, according to some embodiments of the invention.

Reference is also made to FIGS. 3C, 3D and FIG. 3E, which are schematic 3D diagrams of a device 200 for operating a product outlet door 96 of a vending machine 90, including an elevatable basket and a lever-based actuator, according to some embodiments of the invention.

Device 200 may be configured to operate a product outlet door 96 of a vending machine having a horizontal product outlet door rotation axis 96(1). According to some embodiments of the invention, device 200 may include a frame 210, a basket 220 and an actuator 230.

Frame 210 may be mountable within an interior of vending machine 90. For example, frame 210 may be mountable within product delivery compartment 92 of vending machine 90. Frame 210 may support at least some components of device 200. Frame 210 may couple at least some components of device 200 to vending machine 90.

Basket 220 may be received within frame 210. Basket 220 may be configured to receive purchased product 80 from vending machine 90. Basket 220 may be movable within frame 210 between a lowered basket position 220a and an elevated basket position 220b.

Basket 220 may be coupled to product outlet door 96 of vending machine 90. Actuator 230 may be configured to elevate basket 220 from a lowered basket position 220a to an elevated basket position 220b. Elevation of basket 220 from lowered basket position 220a to elevated basket position 220b may cause product outlet door 96 to rotate about its rotation axis 96(1) from its closed position 96a to its open position 96a so as to open product outlet door 96. In this manner, purchased product 80 received in basket 220 may be elevated close to product outlet 94 of vending machine 90 to ease the access of the user to purchased product 80. Basket 220 may include a basket outlet 221 through which the user of vending machine 90 may pull purchased product 80.

Actuator 230 may be configured to lower basket 220 from elevated basket position 220b to lowered basket position 220a. Lowering of basket 220 from elevated basket position 220b to lowered basket position 220a may cause product outlet door 96 to freely rotate about its rotation axis 96(1) from its open position 96b to its closed position 96a due to gravity force acting on product outlet door 96 so as to cause product outlet door 96 to close.

In some embodiments, basket 220 may include sliders 222 on one or more external lateral surfaces of basket 220. Sliders 222 may cause direct and smooth movement of basket 220 within frame 210. For example, each of sliders 222 may include a wheel rotatably coupled to one of external lateral surfaces of basket 220 and configured to roll over frame 210 when basket 220 is elevated or lowered within frame 210.

In some embodiments, device 200 may include at least one door wheel 226. The at least one door wheel 226 may be coupled to product outlet door 96 and may be rotatable with respect to product outlet door 96 about at least one door wheel rotation axis 226(1). In some embodiments, at least one door wheel rotation axis 226(1) may be parallel, or substantially parallel, to product outlet door rotation axis 96(1). The at least one door wheel 226 may be coupled to product outlet door 96 such that the at least one door wheel 226 may contact at least one edge 224 of basket 220 (e.g., at least one top base edge as shown in FIGS. 3A-3B, 3C-3D and 3E). Elevation/lowering of basket 220 may cause the at least one door wheel 226 to roll over at least one edge 224 of basket 220 and to cause product outlet door 96, coupled to the at least one door wheel 226, to rotate between its closed position 96a and its open position 96b, depending on the direction of movement of basket 220.

Coupling basket 220 to product outlet door 96 via the at least one door wheel 226 may eliminate a need for rigid coupling of basket 220 to product outlet door 96. Having no rigid coupling between basket 220 and product outlet door 96 may enable manual opening of product outlet door 96 independent of operation of device 200. Having no rigid coupling between basket 220 and product outlet door 96 may enable product outlet door 96 to close due to gravity force acting on product outlet door 96.

In some embodiments, actuator 230 may include a cable 232, a lever rod 234 having a lever rod rotation axis 234(1), and a motor 236. Cable 232 may be coupled to basket 220 and to lever rod 234. In some embodiments, actuator 230 may include one or more cable guide rollers 238. Lever rod 234 may be coupled to frame 210 and may be rotatable with respect to frame 210 about lever rotation axis 234(1).

Motor 236 may be a rotation motor configured to rotate lever rod 234. Rotation of lever rod 234 from a first lever rod position 234a to a second lever rod position 234b may cause elevation of basket 220 from lowered basket position 220a to elevated basket position 220b and may cause opening of product outlet door 96. As long as lever rod 234 is in second lever rod position 234b, basket 220 may remain in elevated basket position 220b and product outlet door 96 may remain open.

Rotation of lever rod 234 from second lever rod position 234b to first lever position 234a truly cause lowering of basket 220 from elevated basket position 220b to lowered basket position 220a and may cause closure of product outlet door 96 due to gravity force acting on product outlet door 96.

In some embodiments, motor 236 may be configured to rotate lever rod 234 in one direction only (e.g., in a clockwise or counterclockwise direction) to cause both elevation and lowering of basket 220 and opening and closing of product outlet door 96. This may, for example, eliminate a need for an electric circuity that controls the direction of rotation of motor 236. In some embodiments, motor 236 may be coupled to frame 110.

In some embodiments, actuator 230 may include a transmission 239 (e.g., as shown in FIG. 3E). Transmission 239 may, for example, include one or more gears, one or more belts, etc. Transmission 239 may transmit rotations of motor 236 to lever rod 234. Transmission 239 may provide flexibility in positioning of motor 236 and/or lever rod 234 within device 100 so as to provide more compact device 100.

In some embodiments, device 100 may include a controller 240. Controller 240 may operate actuator 230. In some embodiments, controller 240 may receive, from a processing of vending machine 90, one or more control signals indicative of a delivery of purchased product 80 into product delivery compartment 92 of vending machine 90. Upon receiving the one or more control signals, controller 240 may cause actuator 230 to elevate basket 220 from lowered basked position 220a to elevated basket position 220b so as to open product outlet door 96. In some embodiments, controller 240 may be configured to cause actuator 230 to hold basket 220 in elevated basket position 220b for a predefined time interval. After the predefined time interval has lapsed, controller 240 may control actuator 230 to lower basket 220 from elevated basket position 220b to lowered basket position 220a so as to cause product outlet door 96 to close. In some embodiments, device 200 may include one or more sensors 250 configured to detect an obstacle (e.g., a hand of the user) within product outlet 94/product delivery compartment 92. For example, one or more sensors 250 may be, or may include, one or more optical sensors. If one or more sensors 250 detect an obstacle within product outlet 94/product delivery compartment 92, controller 240 may cause actuator 230 to hold basket 220 in elevated basket position 220b, e.g., for addition predefined time interval or until one or more sensors 250 indicate that the obstacle has been removed.

In some embodiments, controller 240 may operate motor 236. Upon receiving the one or more control signals, controller 240 may control motor 236 to rotate lever rod 234 from first lever rod position 234a to second lever rod position 234b so as to elevate basket 220 from lowered basket position 220a to elevated basket position 220b and to open product outlet door 96. In some embodiments, device 100 may include a first limit sensor 252 configured to detect that basket 220 has reached elevated basket position 220b, and controller 240 may control motor 236 to terminate rotation of lever rod 234. In some embodiments, controller 240 may control motor 236 to hold lever rod 234 in second lever rod position 234b for the predefined time interval so as to keep product outlet door 96 open for the predefined time interval. After the predefined time interval has lapsed, controller 240 may control motor 236 to rotate lever rod 234 from second lever position 234b to first lever rod position 234a so as to cause product outlet door 96 to close. In some embodiments, device 200 may include a second limit sensor 254 configured to detect that basket 220 has reached lowered basket position 220a, and controller 240 may control motor 236 to terminate rotation of lever rod 234. Each of first limit sensor 252 and second limit sensor 254 may, for example, include at least one of a micro switch, limit switch, inductive sensor, capacitive sensor, optical sensor, etc.

In some embodiments, device 200 may include one or more sensors 256 configured to detect whether product outlet door 96 of vending machine 90 is in its closed position 96a or in its open position 96b. For example, one or more sensors 256 may be, or may include, one or more optical sensors. Controller 240 may be configured to further control the operation of actuator 230 (e.g., the operation of motor 236) based on readings of one or more sensors 256.

In various embodiments, device 200 may include one or more sensors 258 (e.g., one or more limit sensors) configured to detect the rotation of motor 236 and/or to determine the rotational position (e.g., first/second rotational position) of motor 236. Controller 240 may control motor 236 based on readings of one or more sensors 258.

In various embodiments, motor 236 may be configured to stop or to rotate to its initial position if a current applied on motor 236 exceeds a predefined current value. Current that exceeds the predefined current value may be indicative of, for example, a large force being applied on, for example, basket 230. This may, for example, prevent damage to motor 236.

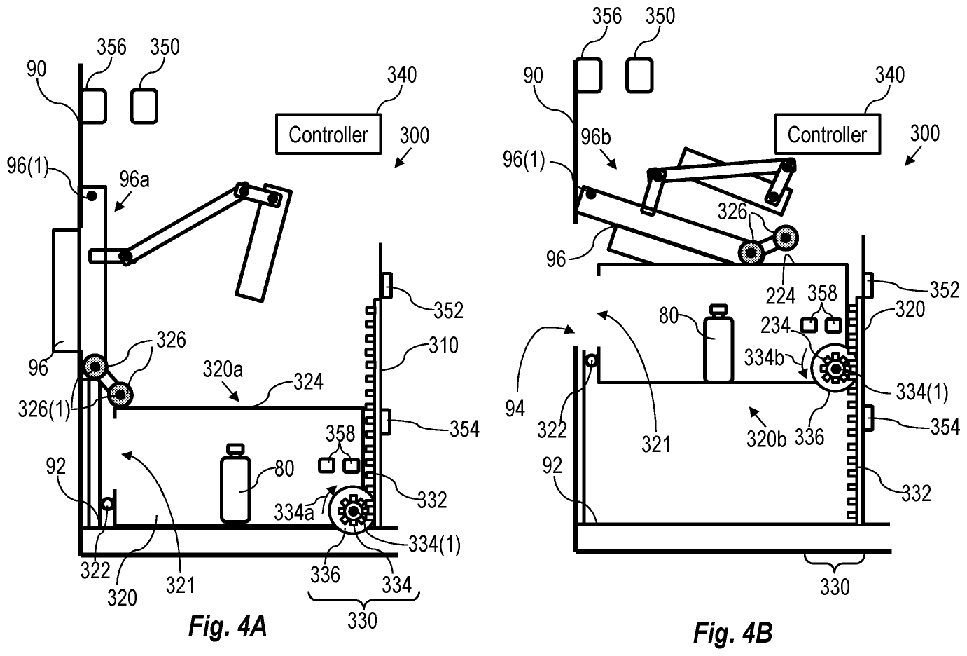

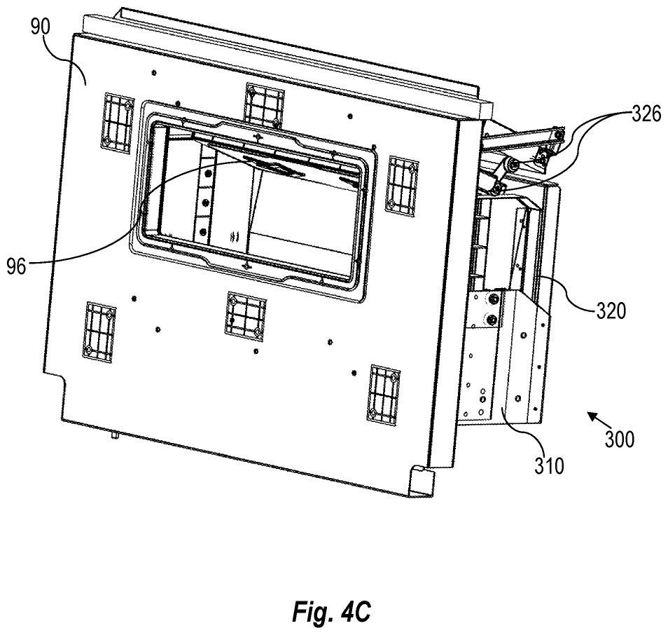

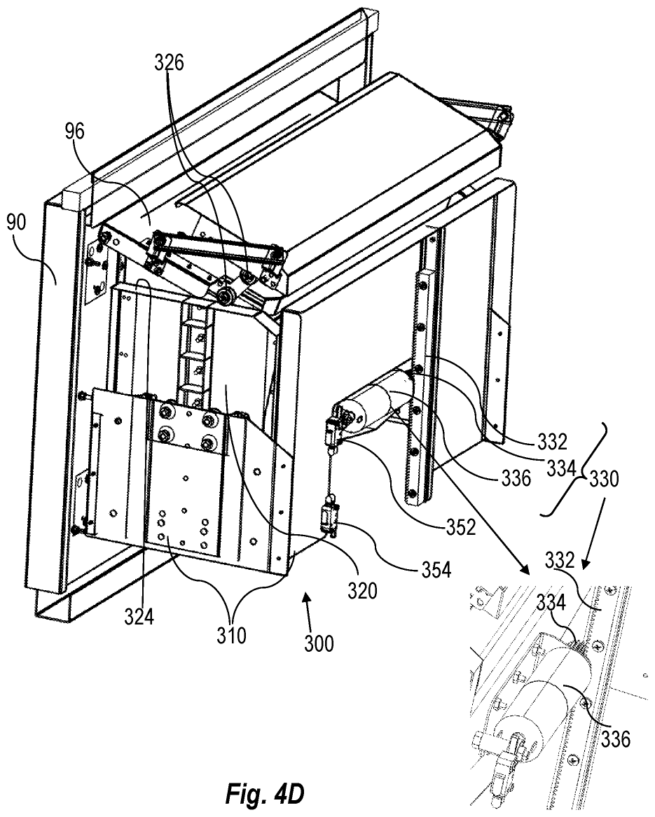

Reference is now made to FIGS. 4A and 4B, which are schematic illustrations of a device 300 for operating a product outlet door 96 of a vending machine 90, including an elevatable basket and a gear-based actuator, according to some embodiments of the invention.

Reference is also made to FIGS. 4C and 4D, which are schematic 3D diagrams of a device 300 for operating a product outlet door 96 of a vending machine 90, including an elevatable basket and a gear-based actuator, according to some embodiments of the invention.

Device 300 may be configured to operate a product outlet door 96 of a vending machine having a horizontal product outlet door rotation axis 96(1). According to some embodiments of the invention, device 300 may include a frame 310, a basket 320 and an actuator 330.

Frame 310 may be mountable within an interior of vending machine 90. For example, frame 310 may be mountable within product delivery compartment 92 of vending machine 90. Frame 310 may support at least some components of device 300. Frame 310 may couple at least some components of device 300 to vending machine 90.

Basket 320 may be received within frame 310. Basket 320 may be configured to receive purchased product 80 from vending machine 90. Basket 320 may be movable within frame 310 between a lowered basket position 320a and an elevated basket position 320b.

Basket 320 may be coupled to product outlet door 96 of vending machine 90. Actuator 30 may be configured to elevate basket 320 from a lowered basket position 320a to an elevated basket position 320b. Elevation of basket 320 from lowered basket position 320a to elevated basket position 320b may cause product outlet door 96 to rotate about its rotation axis 96(1) from its closed position 96a to its open position 96a so as to open product outlet door 96. In this manner, purchased product 80 received in basket 320 may be elevated close to product outlet 94 of vending machine 90 to ease the access of the user to purchased product 80. Basket 320 may include a basket outlet 321 through which the user of vending machine 90 may pull purchased product 80.

Actuator 330 may be configured to lower basket 320 from elevated basket position 320b to lowered basket position 320a. Lowering of basket 320 from elevated basket position 320b to lowered basket position 320a may cause product outlet door 96 to freely rotate about its rotation axis 96(1) from its open position 96b to its closed position 96a due to gravity force acting on product outlet door 96 so as to cause product outlet door 96 to close.

In some embodiments, basket 320 may include sliders 322 on one or more external lateral surfaces of basket 320. Sliders 322 may cause direct and smooth movement of basket 320 within frame 310. For example, each of sliders 322 may include a wheel rotatably coupled to one of external lateral surfaces of basket 320 and configured to roll over frame 310 when basket 320 is elevated or lowered within frame 310.

In some embodiments, device 300 may include at least one door wheel 326. At least one door wheel 326 may be coupled to product outlet door 96 and may be rotatable with respect to product outlet door 96 about at least one door wheel rotation axis 326(1). At least one door wheel rotation axis 326(1) may be parallel, or substantially parallel, to product outlet door rotation axis 96(1). At least one door wheel 326 may be coupled to product outlet door 96 such that the at least one door wheel 226 may contact the at least one edge 324 of basket 320 (e.g., at least one top base edge as shown in FIGS. 3A-3B, 3C-3D and 3E). Elevation/lowering of basket 320 may cause the at least one door wheel 326 to roll over the at least one edge 324 of basket 320 and to cause product outlet door 96, coupled to the at least one door wheel 326, to rotate between its closed position 96a and its open position 96b, depending on the direction of movement of basket 320.

Coupling basket 320 to product outlet door 96 via the at least one door wheel 326 may eliminate a need for rigid coupling of basket 320 to product outlet door 96. Having no rigid coupling between basket 320 and product outlet door 96 may enable manual opening of product outlet door 96 independent of operation of device 300. Having no rigid coupling between basket 320 and product outlet door 96 may enable product outlet door 96 to close due to gravity force acting on product outlet door 96.

In some embodiments, actuator 330 may include a linear gear 332, a circular gear 334 meshed with linear gear 332, and a motor coupled to circular gear 334 and configured to rotate circular gear :3:34 about a circular gear rotation axis 334(1).

In some embodiments, linear gear 332 may be coupled to frame 310 and motor 336 may be coupled to basket 320. Motor 336 may be configured to rotate circular gear 334 in a first rotation direction 334a to elevate basket 320 from lowered basket position 320a to elevated basket position 320b and to cause opening of product outlet door 96. Motor 336 may be configured to rotate circular gear 334 in a second rotation direction 334b (e.g., that is opposite to first rotation direction 334a) to lower basket 320 from elevated basket position 320b to lower basket position 320a and to cause closure of product outlet door 96 due to gravity force acting on product outlet door 96.

In some embodiments, device 300 may include a controller 340. Controller 340 may operate actuator 330. In some embodiments, controller 340 may receive, from a processing of vending machine 90, one or more control signals indicative of a delivery of purchased product 80 into product delivery compartment 92 of vending machine 90. Upon receiving the one or more control signals, controller 340 may cause actuator 330 to elevate basket 320 from lowered basked position 320a to elevated basket position 320b so as to open product outlet door 96. In some embodiments, controller 340 may be configured to cause actuator 330 to hold basket 320 in elevated basket position 320b for a predefined time interval. After the predefined time interval has lapsed, controller 340 may control actuator 330 to lower basket 320 from elevated basket position 320b to lowered basket position 320a so as to cause product outlet door 96 to close. In some embodiments, device 300 may include one or more sensors 350 configured to detect an obstacle (e.g., a hand of the user) within product outlet 94/product delivery compartment 92. For example, one or more sensors 350 may be, or may include, one or more optical sensors. If one or more sensors 350 detect an obstacle within product outlet 94/product delivery compartment 92, controller 340 may cause actuator 330 to hold basket 320 in elevated basket position 320b, for addition predefined time interval or until one or more sensors 350 indicate that the obstacle has been removed.

In some embodiments, controller 340 may operate motor 336. Upon receiving the one or more control signals, controller 340 may control motor 336 to rotate circular gear 334 in first rotation direction 334a so as to elevate basket 320 from lowered basket position 320a to elevated basket position 320b and to open product outlet door 96. In some embodiments, device 300 may include a first limit sensor 352 configured to detect that basket 320 has reached elevated basket position 320b, and controller 340 may control motor 336 to terminate rotation of circular gear 334. In some embodiments, controller 240 may control motor 336 to terminate the rotation of circular gear 334 for the predefined time interval after basket 320 has reached elevated basket position 320b to keep product outlet door 96 open for the predefined time interval. After the predefined time interval has lapsed, controller 340 may control motor 336 to rotate circular gear 334 in second rotation direction 334b so as to lower basket 320 from elevated basket position 320b to lowered basket position 320a to cause product outlet door 96 to close. In some embodiments, device 300 may include a second limit sensor 354 configured to detect that basket 320 has reached lowered basket position 320a, and controller 240 may control motor 336 to terminate rotation of circular gear 334. Each of first limit sensor 352 and second limit sensor 354 may, for example, include at least one of a micro switch, limit switch, inductive sensor, capacitive sensor, optical sensor, etc.

In some embodiments, device 300 may include one or more sensors 356 configured to detect whether product outlet door 96 of vending machine 90 is in its closed position 96a or is in its open position 96b. For example, one or more sensors 356 may be, or may include, one or more optical sensors. Controller 340 may be configured to further control the operation of actuator 330 (e.g., the operation of motor 336) based on readings of one or more sensors 356.

In various embodiments, device 300 may include two or more sensors 358 (e.g., one or more limit sensors) configured to detect the rotation of motor 336 and/or to determine the rotational position (1 e.g., first/second rotational position) of motor 336. Controller 340 may control motor 336 based on readings of two or more sensors 358.

In various embodiments, motor 336 may be configured to stop or to rotate to its initial position if a current applied on motor 336 exceeds a predefined current value. Current that exceeds the predefined current value may be indicative of, for example, a large force being applied on, for example, basket 330. This may, for example, prevent damage to motor 336, circular gear 334 and/or linear gear 332.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A device for operating a product outlet door of a vending machine having a horizontal product outlet door rotation axis, the device comprising:
a frame mountable within an interior of a vending machine;
a lever comprising a lever rod coupled to the frame and rotatable with respect to the frame about a lever rod rotation axis, wherein the lever rod is couplable to the product outlet door of the vending machine; and
an actuator configured to rotate the lever rod from a first lever rod position to a second lever rod position to cause the product outlet door to rotate about its rotation axis from its closed position to its open position so as to open the product outlet door.

2. The device of claim 1, wherein the actuator is configured to enable the lever rod to freely rotate between the second lever rod position and the first lever rod position to cause the product outlet door to freely rotate its rotation axis from its open position to its closed position due to gravity force acting on the product outlet door so as to cause the product outlet door to close.

3. The device of claim 1, comprising:
a door pulley couplable to the product outlet door and rotatable with respect to the product outlet door about a door pulley rotation axis;
wherein the door pulley contacts the lever rod such that rotation of the lever rod causes the door pulley to at least one of roll over and skim on the lever rod and causes the product outlet door to rotate about its rotation axis so as to cause the product outlet door to open or to close.

4. The device of claim 1, wherein the lever rod comprises:
a first lever rod portion; and
a second lever rod portion at an obtuse with respect to the first lever rod portion;
wherein the lever rod rotation axis is between the first lever rod portion and the second lever rod portion.

5. The device of claim 1, wherein the actuator comprises:
a disc cam coupled to the frame and rotatable with respect to the frame about a disc cam rotation axis, wherein the disc cam is configured to:
when rotated from a first disc cam position to a second disc cam position, cause rotation of the lever rod from the first lever rod position to the second lever rod position so as to open the product outlet door; and
when rotated from the second disc cam position to the first disc cam position, enable the lever rod to freely rotate between the second lever rod position and the first lever rod position due to gravity force acting on the product outlet door so as to cause the product outlet door to close; and
a motor configured to rotate the disc cam.

6. The device of claim 5, wherein the motor is configured to rotate the disc cam in one direction.

7. The device of claim 5, wherein the disc cam comprises:
a disc cam pulley coupled to the disc cam and rotatable with respect to the disc cam about a disc cam pulley rotation axis;
wherein the disc earn pulley contacts the lever rod such that rotation of the disc cam causes the disc cam pulley to at least one of roll over and skim on the lever rod so as to cause rotation of the lever rod between the first lever rod position and the second lever rod position.

8. A product delivery box for a vending machine, wherein the product delivery box comprises a device according to claim 1.

9. A vending machine comprising a device according to claim 1.

10. A device for operating a product outlet door of a vending machine having a horizontal product outlet door rotation axis, the device comprising:
a frame mountable within an interior of a vending machine;
a basket configured to receive a purchased product from vending machine, wherein the basket is couplable to the product outlet door of the vending machine and movable within the frame between a lowered basket position and an elevated basket position; and
an actuator configured to elevate the basket from a lowered basket position to an elevated basket position to cause the product outlet door to rotate about its door rotation axis front its closed position to its open position so as to open the product outlet door.

11. The device of claim 10, wherein the actuator is configured to lower the basket front the elevated basket position to the lowered basket position to cause the product outlet door to freely rotate about its rotation axis from its open position to its closed position due to gravity force acting on the product outlet door so as to cause the product outlet door to close.

12. The device of claim 10, comprising:
at least one door wheel couplable to the product outlet door and rotatable with respect the product outlet door about at least one door pulley rotation axis;
wherein the at least one door pulley contacts at least one top lateral edge of the basket such that elevation and lowering of the basket causes the at least one door wheel to roll over the at least one top lateral edge of the basket and causes the product outlet door to rotate about its rotation axis so as to cause the product outlet door to open or to close.

13. The device of claim 10, wherein the actuator comprises:
a cable coupled to the basket;
a lever comprising a lever rod coupled to the frame and rotatable with respect to the frame about a lever rod rotation axis, wherein the lever rod is coupled to the cable; and
a motor configured to:
rotate the lever rod from a first lever rod position to a second lever rod position to elevate the basket from the lowered basket position to the elevated basket position so as to open the product outlet door; and
rotate the lever rod front the second lever rod position to the first lever rod position to lower the basket from the elevated basket position to the lowered basket position so as to cause the product outlet door to close.

14. The device of claim 10, wherein the actuator comprises:
a linear gear coupled to the frame;
a circular gear meshed with the linear gear; and
a motor coupled to the basket and coupled to the circular gear to rotate the circular gear about a circular gear rotation axis, wherein the motor is configured to:
rotate the circular gear in a first rotation direction to elevate the basket from the lowered basket position to the elevated basket position and to cause opening of the product outlet door; and
rotate the circular gear in a second rotation direction to lower the basket from the elevated basket position to the lower basket position and to cause closure of the product outlet door due to gravity force acting on the product outlet door.

15. A product delivery box for a vending machine, wherein the product delivery box comprises a device according to claim 10.

16. A vending machine comprising a device according o claim 10.
